(19) United States
(12) Patent Application Publication
(10) Pub. No.: US 2017/0068806 A1
(43) Pub. Date: Mar. 9, 2017

(54) METHOD AND DEVICE FOR IDENTIFYING OR AUTHENTICATING A PERSON AND/OR AN OBJECT USING DYNAMIC ACOUSTIC SECURITY INFORMATION

(71) Applicant: Friedrich KISTERS, Kreuzlingen (CH)

(72) Inventor: Friedrich KISTERS, Kreuzlingen (CH)

(21) Appl. No.: 15/120,403

(22) PCT Filed: Feb. 19, 2015
(86) PCT No.: PCT/EP2015/053543

§ 371 Date: Aug. 19, 2016

(30) Foreign Application Priority Data
Feb. 20, 2014 (DE) 102014002207.2

(51) Int. Cl. G06F 21/32; G10L 21/06; G10L 25/51

(52) U.S. Cl. CPC G06F 21/32; G10L 25/51; G10L 21/06

(57) ABSTRACT

The invention relates to methods of identifying or authenticating a person and/or an object using an authentication device comprising one or more security information, which consist of at least one security information known to the authentication device and at least a changing dynamic security information, wherein the person and/or object is/are then positively authenticated, if the transmitted known security information matches the security information stored in the storage means and if the forwarded dynamic security information has been changed, at least partially, vis-à-vis the security information stored in the storage means in comparison to the last inquiry.

### TECHNICAL FIELD

The present invention relates to a method for identification or authentication of a person and/or an object using individual, preferably acoustic means or related digital strings, which comprise dynamic security information. Further, the invention provides an authentication means for carrying out the method according to the present invention.

### STATE OF THE ART

For a valid identification or authentication of a person and/or object, different methods are known, in which a safety inquiry is made on the basis of predetermined parameters. For example, authentication can be carried out by entering a code, a password, a key or by means of biometric features. Besides, there are methods in which a user authentication is done using means of acoustic signals, for example, in connection with a mobile terminal. Such a device is described, for example, in WO 97/17791 A2, wherein first a connection set-up is done with an authentication server, and which then sends a random number via DTMF (Dual Tone Multi-Frequency). In this connection, an acoustic signal is calculated, encoded and subsequently sent back to the authentication server. Only when the transmitted acoustic security information is correct, the calling subscriber is allowed for the associated performance characteristics.

In addition to acoustic signals as sounds or melodies, the human voice can be used in the context of speech recognition for authentication or identification of a user or a telecommunications device. For example, in EP 0 896 711 B1 an access control is carried out by checking one or more speech utterances of a speaker. The method comprises voice recognition of a speaker, in which a predictive model is used, with which the person's identity is verified in response to a speech pattern of his/her voice. Among other things, the physiological characteristics of human voice are considered. A disadvantage with such methods is that the human voice or other rigid acoustic security information that is based on a defined, stored pattern can relatively easily be copied, whereby an unauthorized user can authenticate or identify him or her.

DE 10 2007 012 953 A1 follows a different approach, in which a voice communication between telecom subscribers and the use of biometric key is encrypted. The biometric key is obtained from a biometric feature of one of the subscriber and communicated to the other party as session key. The key can be regenerated, for instance, every time by capturing the biometric data via a suitable sensor of the telecommunication device (e.g. a fingerprint sensor). For transmission via the voice channel, a modulated acoustic signal can be generated by the program component suitable for transmission via the voice channel. This can, for example, be a sequence of sounds or a melody, in which a random number is embedded by corresponding modulation. By demodulation of the acoustic signal received via the voice channel, the random number can be recovered. The random number is then transferred via a card reader to a chip card, for example. This random number is signed using the secret key of the one subscriber and the signed random number is retransmitted from the mobile unit of the subscriber to the mobile device of the other party. This is carried out again via the voice channel by generating a correspondingly modulated acoustic signal. The transmission of the random number and/or the retransmission of the signed random number also concern a rigid safety feature that can be easily hacked by potential hacker attacks. The transmission of the key by means of a voice channel represents merely a “camouflage” of the actual security information.

Further, there are combined methods, in which an authentication takes place based on a voice profile in combination with at least one stored phone number. For example, such a method is described in DE 10 2006 047 793 A1. Even such combined methods comprise single, rigid security features, which, in combination, enhance the safety; but can be copied and thus bypassed.

US 2013/0262873 A1 describes a method for biometric authentication of a user of a mobile communication device, in which a user ID, a password and biometric user information are utilized for authentication.

US 2007/0147669 A1 discloses a method for authentication of fingerprint and other biometric information which is based on the analysis of changing user information. For example, overlapping images of fingerprints are generated at various recording times and compared with one another. In doing so, regions are consciously analyzed that exactly match, while other regions between the recording intervals are subjected to a change in subject. Such changes can occur, for example, if a user places his finger with varying pressure on the scanning device, whereby a slightly different result occurs.

WO 2010/066269 A1 describes a method for verification of a person based on speech recognition. For this, a language model, for example, is stored in a database or a speech utterance of the subscriber is used for authentication.

### DESCRIPTION OF THE INVENTION

Against this background, it is an object of the present invention to provide an improved method, in which a higher security level is enabled for identification or authentication of a person and/or an object.

This object is solved by a method having the features of claim 1 and a corresponding device for carrying out the method.

Said method uses a combination of rigid and dynamic security information for the identification or authentication of a person and/or object. The dynamic security information cannot or hardly be identified by a hacker or an unauthorized person. The dynamic security information in turn consists of any information which can be utilized as security element. Normally, this is a rigid security information, which is activated by a dynamic factor and thereby converted to a dynamic security information. In a preferred embodiment, the respective underlying security information is a code, an acoustic safety feature or a biometric feature. This is supplemented before the actual transfer either by dynamic security information, or converted by dynamic security information that is preferably locally present. On the contrary of the known security information, the dynamic security information can be of any kind. Preferably, the dynamic security information and the known security information are of the same type, for example, a code. Even dynamic security elements can be combined with other dynamic security elements or changed by these. Dynamic security elements can also become static security elements, in particular for subsequent authentication operations. They can then be supplemented by new dynamic security elements.

The known security information is assigned to a specific person or a specific object. Preferably, in such a security feature, it relates to a biometric feature or another individual or individualized feature. For example, a code can be generated from the profile of a human voice, which in turn is assigned to a person or an object.

The subject-matter of the invention concerns a stationary, mobile or portable device which shall be authenticated either by itself or its users. For example, the object can relate to a mobile terminal, preferably a telecom device, a cellular phone, a smart phone, a PC, a tablet. The authentication of the person can be done via an input device of a stationary system or the object.

Said inventive method is thus based on the use of static and/or rigid, preferably acoustic, safety information and dynamic security information. A rigid security information is a security information which is known to the authentication device, such as a mobile or stationary database server. An acoustic security information can be anyone of one or more signal curves, a tone or a mixture of sounds, a melody, a noise, a voice, or any other security information used in the acoustics. Among them, for example, a touch screen is to be understood, in which the acoustic information is converted into notation. The decoding of this notation in tonal form provides an acoustic security information which can be used for authentication purposes in accordance with the present invention. Additionally, further dynamic security features can also be considered.

A dynamic security information refers to a changing security information that is not necessarily known to the authentication device and that changes between two inquiries. An inquiry in this case needs not necessarily to be a data exchange. For example, a query time may be defined as the beginning and the end of a session (e.g. logging into a system), while there are several queries in the session, in which the dynamic security features remain unchanged. An inquiry thus defines the time at which the database communicating with the authentication device is updated with the new security information. While the known security information does preferably not change between two inquiries and is thus “rigid”, the dynamic security information changes in the unexpected ways between inquiries. This change can be carried out either locally, i.e. carried out on the terminal of a user, or centrally, for example in a server environment, or on both sides. The central database needs not necessarily to be stationary. It can also be integrated in a mobile device. In addition, multiple databases are possible, in which the data can be divided via a specific key, and thus, in itself, do not constitute a usable content.

In case of a dynamic security information, the manner and the degree of change are not readily predictable. A targeted modification can be caused randomly, rule-dependent or by internal or external influences. In contrary to the known security information, the dynamic information security changes during two specified inquiry time points. A change of the security information preferably takes place in the device that is used for authentication or identification, e.g. a mobile terminal such as a mobile phone. A potential hacker, therefore, does not know how the dynamic security information between inquiries will be altered or modified and on what rules this change is based. This change can take place without rules, or based on local circumstances, or with defined rules. These “rules” are then known only locally and/or to the authentication device, so that a potential hacker had to take possession of both the authentication device and the mobile terminal to launch a possible attack. Because of the change of the dynamic security information that cannot be foreseen by the unauthorized user and the combination with known rigid acoustic safety information, a higher level of security is achieved as it is the case of using rigid acoustic safety information (such as fixed tones or the human voice). Since the dynamic security information is developed continuously, a potential hacker does not know how this security information is further developed and as per what rule a respective change takes place.

The individual security information is preferably based on biometrics features. Preferred is acoustic safety information that comprises acoustic signals, envelope curves, melodies, tone sequences, sounds, voices, languages and voice parts, intonations and mode of expressions while speaking, voice profiles, noise, which can be picked up by means of acoustics and/or can be represented. Furthermore, said combinations and mixtures of such acoustic safety comprises, for example, polyphonic melodies, tone sequences of different frequency and/or intensity, signal mixtures of acoustic signals, tones, noises, melodies, etc. Acoustic signals can be recorded, for example, via a microphone or another sensor. Acoustic security information can be displayed audio-visually by appropriate processing means, for example, by signalling and sound curves, signal sequences, but also by symbols such as notation or other signs. Preferably, the known and/or the dynamic security information can be audio-visually represented by curves, signal sequences, symbols, colours, pictures, letters, numbers, notation or other signs.

A dynamic security feature, digitally depicted, corresponds to a dynamic, digital security information that may be present, for example, in the form of a code. This digital security information can be used to authenticate a person by assigning the digital information to a person. Preferably, such a code, similar to a network address, would be assigned to a particular person or an object and would, at least partially, change dynamically in an unpredictable manner. In a preferred embodiment, the voice would not be transmitted and checked without change (1:1), but partially modulated by local changing factors and transmitted afterwards. In another variant, this voice would be accompanied by a code, which remains partially static and partially also modulated. Likewise, for example, the profile of a fingerprint can be converted into a code and served as security information. Besides, the profile itself can be stored, for example in the form of a digital scan, as security information.

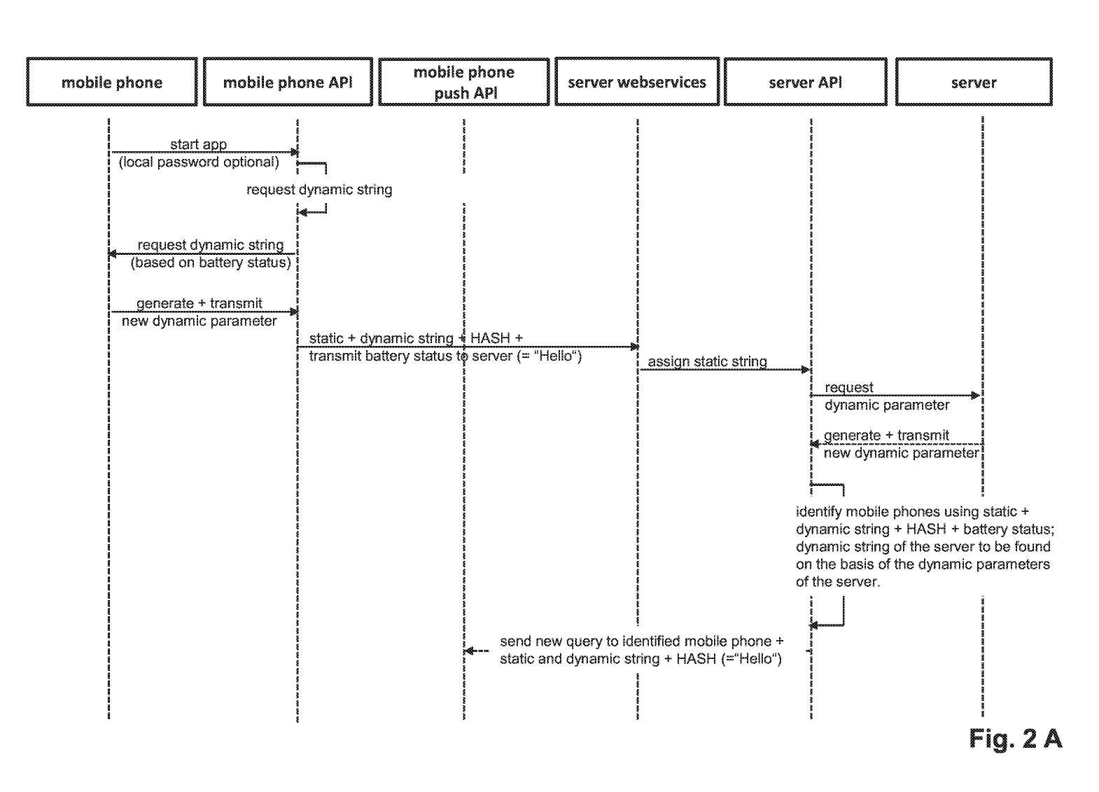

According to the invention, it is now provided in a preferred variant that the authentication is performed through one or more acoustic safety information, wherein the acoustic security information comprise known acoustic security information and changing dynamic security information, that does not necessarily have to be acoustic. The known security information is “rigid” security information that is preferably known only to the authentication device and assigned to a particular person or a particular object. In this way, a pre-authentication or identification of the person or the object to be registered is possible (see FIG. 2). A service provisioning request can also occur as an immediate consequence of previous authentication, to which due to pre-authentication there will be no further change in the dynamic security information, but under circumstances there may be a swap of the request direction. Due to this swap of the request direction, instead of the inquiring forger the correct identity of the carrier would be automatically requested in the event of a copied identity, and thereby its dynamic security factors would be updated and the earlier requesting forger would be exposed immediately. The known security information may also be a signal mix or a signal profile, whereby an “acoustic fingerprint” is created. As such, the known security information “in itself” can be quite dynamic (a voice progression can also be dynamic, whereby a profile is created), wherein, according to the invention, the said dynamic security information is so characterized that it changes continuously and namely in a way that an allocation to a particular person or a particular object is no longer easily possible. In this case, the change preferably relates to the state of dynamic security information between two inquiries, i.e. between the times in which the dynamic security information as present in the database is successfully replaced by a current dynamic security information.

According to the invention, it is further provided that the known security information is at least known to the local authentication device. Preferably, the dynamic security information is known at the time of the last query or update only to the central authentication device. However, the dynamic security are constantly changing, so that in a subsequent authentication, the dynamic security information present in the system is replaced or updated by a current dynamic security information. A potential hacker or counterfeiters therefore does not know what current dynamic security information is currently stored in the system. At best, he receives inferences to the known, “rigid” security information.

According to the invention it is further provided that a storage means for depositing acoustic security information is provided. The storage means can, for example, be a disk or part of a recording apparatus. Preferably, in case of the storage means it relates to a storage medium such as a hard disk or a magnetic data disk. The storage medium is preferably a component of a central or local mobile database.

Any person or object that is known to the system is characterized in such an embodiment by a profile, preferably an acoustic signal profile, comprising several security information. Any person or object thus comprises acoustic security information that is specific to the person or the object. In a further procedural step, these acoustic security information or parts thereof are allocated to a particular person or object. The object can be any object that needs to be identified or authenticated in any way. At the time of authentication (for example, during registration of a person in a service system) known acoustic security information, generated by the person to be identified/authenticated or stored in the object, is transmitted via a communication device. The transfer of security information can take place acoustically, analogous or digitally, and are first altered by locally changeable dynamic factors. In a further variant, the security information to be transmitted between other dynamic security information can be mixed. If required, the security information can also be encrypted or converted into another signal (for example, analog to digital or vice versa). The communication takes place, for example, via a wireless or wired connection between a communication device and the authentication device. The authentication device may, for example, be part of a central database. The acoustic information may then be made visible in some other way, for example, in the form of an image or a code by a suitable terminal device.

The known security information and dynamic security information are transmitted at the time of authentication (or another random or specified time-point) to the central, local or mobile database via the communication device. Subsequently, the transmitted known security information and the dynamic security information are compared with the known security information stored in the storage means and the dynamic security information. In principle, the known security information may indeed even be changed dynamically (for example, the diction of a voice), but the signal profile will not change so fundamentally that an assignment of the security information to a person or object is no longer possible. The dynamic security information is changed in an embodiment of this invention but in a manner where it is not possible for the system to easily identify or to authenticate a person or an object solely on the basis of this dynamic security information. Preferably the signal profile is altered by local dynamic factors before its transfer to prevent its copying and reusing the original signal profile, e.g. the voice, by unauthorized third parties.

Preferably the security information relates to a signal component of a naturally or artificially generated signal or signal mix. Adding an unpredictably changing dynamic signal component to a known signal component leads to a significant increase of safety during authentication or identification. Should there be a change in the dynamic security information in a mobile terminal (e.g. a mobile phone), then the manner and the extent of the dynamic change cannot be predicted by a possible unauthorized user or hacker. The change in the dynamic security information is preferably carried out based on a specified physical, mathematical or chemical parameter or factors. For example, the change in dynamic security information can be done via a mathematical algorithm. However, a time-based or location-based change in dynamic security information is conceivable. For example, it may be required that depending on the time of day an acoustic signal as dynamic security information changes and/or superimposes the human voice as known security information at the time of authentication. Even ambient noise and characteristics of the carrier of the local database can be considered. In the case of a mobile phone, these may be the charge condition of the battery, the exact geographical position, the number assigned to the current radio cell, the outside temperature, the number and type of currently used or installed apps (software), the walking or running speed, the speech rate, the instantaneous remote site in the event of an active call, the number of SMS sent in the last 60 minutes and many more. Further, various features can influence the modification, combination and superposition of different tone or sound groups in a varying degree. Overlapping can be locally shifted depending on locally occurring unpredictable parameter changes. In an embodiment, the manner and extent of overlapping, however, are known only to the local system and in another only to the central system. In another variant, certain parameters are known to both sides, and in a further variant all parameters to both sides, but normally not their actually occurring change. Depending on how you look at it, the local database carrier relates to the mobile terminal or the central server. In addition, the third and subsequent authentication locations can be additionally consulted to the central server, in order to reduce or eliminate the risks due to the influence of the respective administrators. In addition, it can be provided in a further embodiment that in the authentication device, a rule is deposited. Based on this rule, the dynamic security information is changed. The rule, for example, can provide for a change in the course of signal curves. The dynamic security information can also be modified in variants by the behaviour, the manner of speech of the person to be identified or other specific characteristics of the person or the object, so that it is not predictable in the end.

In one embodiment, the known and/or dynamic security information is generated by a central signal generator and is present in a signal or tone mix. For example, a melody can represent a known security information, which is stored statically in the storage means and is assigned to a specific person and/or a particular object. At the same time, dynamic security information can superimpose this melody as the known security information and can be changed continuously according to an algorithm with or without the addition of unpredictably changing local factors. At the time of authentication, the known and/or dynamic security information, at least the dynamic security information is transmitted from the communication device to the authentication device. This proves that the transmitted known safety information match the known security information value stored in the storage means, and that all defined rules have been complied with. At the same time, the dynamic security information must have changed against the stored dynamic security information of the last inquiry. Exception to this may represent the access request to services immediately after the “handshake” (pre-authentication), to which, depending on the adjustment of security parameters, no dynamic change in the security information must be carried out. In this regard, a kind of pre-authentication is interposed before the authentication of the person or the object according to the invention, wherein a transfer of a security information from a terminal to the authentication device takes place before the current authentication, followed by a return request of authentication to the terminal to which the person or object stored in the storage means.

Immediately after pre-authentication and transmission of the latest dynamic data, in a variant an activation request is made in which the dynamic security information can still match. Due to the change in direction away from the original requestor, security is increased because a hacker can neither trigger the “handshake”, nor the subsequent access request or access port. Only when the dynamic security information has at least partially changed and the known security information matches, the person or the object is positively authenticated. After positive authentication, an access, for example, to a service or to a room to be entered is unlocked.

The dynamic security information, for example, can be present in a complex sound such that they are not recognizable to human. Preferably, the dynamic security information is machine-readable and inaudible to the human ear or cannot be distinguished from the known security information without technical aids. Preferably, the acoustic security information, comprising well-known and dynamic security information, is present in a mixture, in which the individual security information can be displayed and distinguished by technical means. For example, it can be provided that a melody is used for authentication, which is composed polyphonic. Thus, for example, both the first voices of the melody can follow a fixed, rigid tonal sequence and according to the invention can define a known security information. Furthermore, another voice could be provided, in which individual notes can be changed depending on an underlying rule in a way that it is not noticed by the listener. Thus, the melody could be, for example, slowed down or accelerated, or at any authentication timing, a certain tone could be made high- or low-pitched by an interval, or a break could be inserted without changing the melody noticeably. Further, tones can be dynamically added in frequencies not perceptible to the human ear or in the form of “random noise”. The authentication device can preferably differentiate each tonal sequences of individual voices and determine whether the dynamic security information (i.e., in this example, the third voice) has at all changed vis-à-vis the stored dynamic security information of the last scanning time and/or has changed in the prescribed manner. If this is the case, then an authentication or identification is positive. This example shows that the dynamic security information is at least partially superimposed by a known security information.

Preferably, the storage means is part of the authentication device or a central database, in which the security information or data derived therefrom are stored. When updating the database, the stored dynamic security information is replaced by the transmitted dynamic security information and/or their data. If required, an exchange or a conversion of the known acoustic security information can take place so as to enhance the dynamic security information.

In a further variant of the invention, it can be provided that before, during or after authentication, the known security information is converted into a dynamic security information or the dynamic security information into a known security information. In doing so, a higher level of security is achieved because the hacker does not know when and according to which rule the conversion of security information takes place.

The intended change in the dynamic security information can, for example, take place via a shift, increase or decrease, amplification, attenuation, shortening, extension, a replacement or another modification of the security information. For example, the amplitude of a signal curve can be shortened, extended, shifted, attenuated or amplified, or the sound sequence and the pace accelerated or slowed down. In another example, individual note values of a notation can be changed, for example, by changing a note or break value, a key change, the change in rhythm or the addition of an instrument while playing a melody. The dynamic change process facilitates modifying the dynamic security information in a manner that it is known only to the known authentication device. Therefore, a potential hacker would have come in possession of the mobile terminal and the central database and/or the authentication device, in order to have a way to overcome the security prompt. With a foreign or copied mobile terminal it would not be possible for an unauthorized user to positively authenticate or identify vis-à-vis the system.

In a preferred embodiment it is provided that the acoustic security information is assigned dynamic security information in the form of an individual code, a network address, an internet address or any other personal characteristic, wherein the dynamic security information includes both dynamic, changing elements and rigid elements. For example, certain digits in a network address between two inquiries can continuously change in an unforeseeable manner and thus make it impossible for third parties to access the same.

The person and/or the object is/are then positively authenticated, if the transmitted known security information matches with the security information stored in the storage means and the forwarded dynamic security information has at least partially changed vis-à-vis the security information stored in the storage means compared to the last successful inquiry.

The invention further consists of an authentication device, which comprises a read-out unit for security information. An acoustic read-out unit can be a microphone, an optical reader or another recording device for acoustic security information. Further, a communication device is provided for exchanging acoustic safety information.

Using the communication device, the known or dynamic security information is transmitted to a central database server from a mobile terminal. A storage means enables the central deposit and storage of security information that is required for authentication or identification of the person or of the object. In the case of authentication unit, the security information comprises known and variable dynamic security information and the authentication is carried out in accordance with what is described above.

### Ways to Carry Out the Invention and Industrial Applicability:

The invention is illustrated in the following examples:

### 1^{st} Example

A mobile phone should be identified with respect to a central database server. For this, a sound mix of different signals is transmitted from the mobile terminal to the central database server. In the central database server a storage means is located, in which the acoustic memory information is stored, which is assigned to the respective person or the mobile terminal. Further, dynamic security information is stored, which corresponds to the security information of the last inquiry.

During authentication the signal mix is transmitted from a communication device to the central database server. The transmitted signal mix comprises known security information and dynamic security information. The known security information can be, for example, fixed tones or signal sequences, which are deposited as data in the storage means of the central database server. Further, the signal mix comprises dynamic signal components, which vary according to a predetermined rule. The type of change is known only to the central authentication device. For example, it may be provided that the amplitude of a dynamic security information is increased or decreased by a specific value after each authentication. At the authentication time point, the authentication device checks whether this increase conforms to the stored rule. If the dynamics of change is correct, the person or the object is positively authenticated.

The change in the dynamic security information is arbitrary. Instead of increasing or decreasing an amplitude or a signal, for instance, a shift of the signal along the time axis can take place.

### 2^{nd} Example

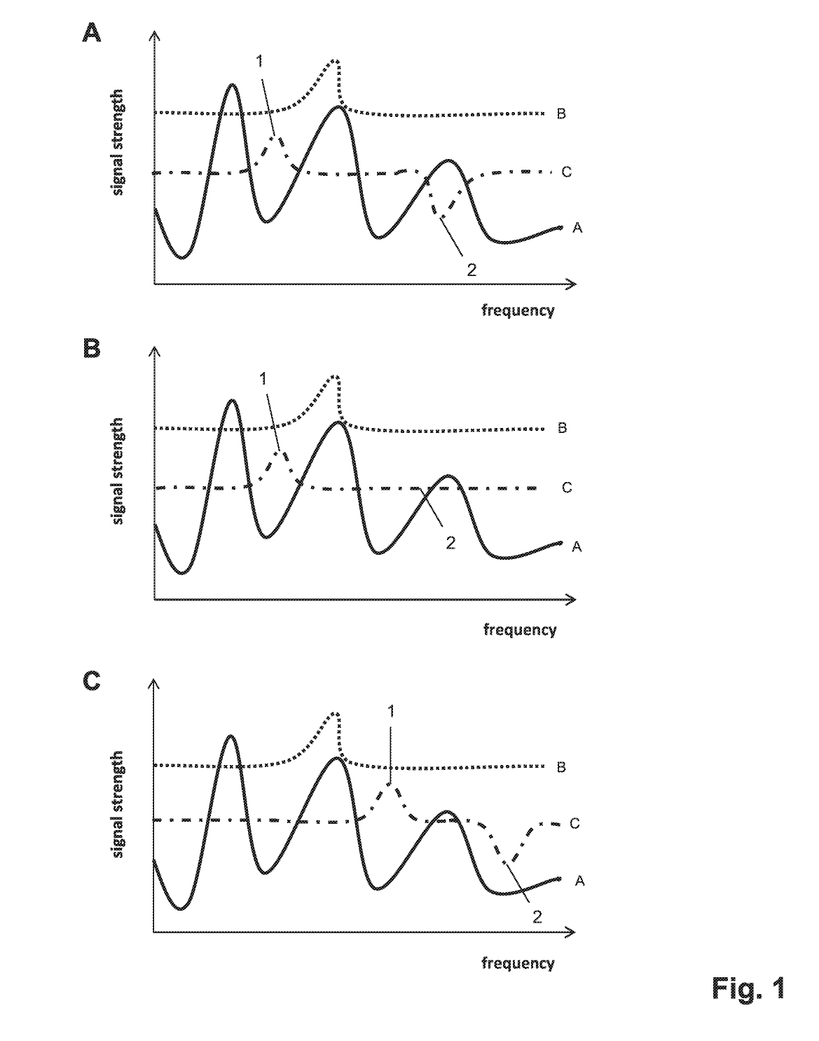

A further example is shown in FIG. 1. In FIG. 1A, different security information A, B, C can be seen. The curves A and B represent the known static security information. Curve C represents the dynamic security information, which changes based on a time- or location-dependent rule or according to a chemical or physical parameter. The cause of the change is known only to the authentication device. A plurality of dynamic curves can overlap: those in which the rules are known at both ends and those in which the dynamic changes occur unpredictably and locally.

### 3^{rd} Example

A mobile terminal, such as a mobile phone, starts locally callable software (App), wherein optionally a local code can be provided. By starting the software, a dynamic string is generated, which in turn is stored in the mobile terminal. The dynamic code changes according to a particular rule. Within the scope of pre-authentication (“handshake”), a query is done from the local database to the central database, whereby the query includes a static and dynamic code, a HASH key and the battery status. Thereby, the user is first pre-authenticated. When the mobile phone is detected, the static part of the code and the HASH key, and the battery status and the dynamic code are stored in a central database. At the same time, a dynamic server code is generated based on a dynamic parameter which is derived from the server. From the server a new query is sent to the mobile terminal, in which the static and dynamic string and the HASH key of the server are transmitted to the local database. The HASH key and the static and dynamic characters are written from the server into the temporary memory. Subsequently, the static and dynamic code, the HASH key and the battery status are sent again to the server. In this case, the parameter “Battery Status” is compared with the stored parameter for identity. Further, the dynamic string must be identical. If both are positive, then access is granted. Based on the HASH key and the battery status a pre-authentication is necessary before the actual authentication is followed by static and dynamic characters.

The dynamic security information C is characterized by a high point 1 and a low point 2. At a first inquiry, the profile comprising known and dynamic security information is deposited on a central database server.

FIG. 1B shows how the dynamic security information C changes, while the known security information A, B remain static. The dynamic security information C has so changed that the high point is 1 has remained, but the low point C was eliminated. The curve is now flat at this point.

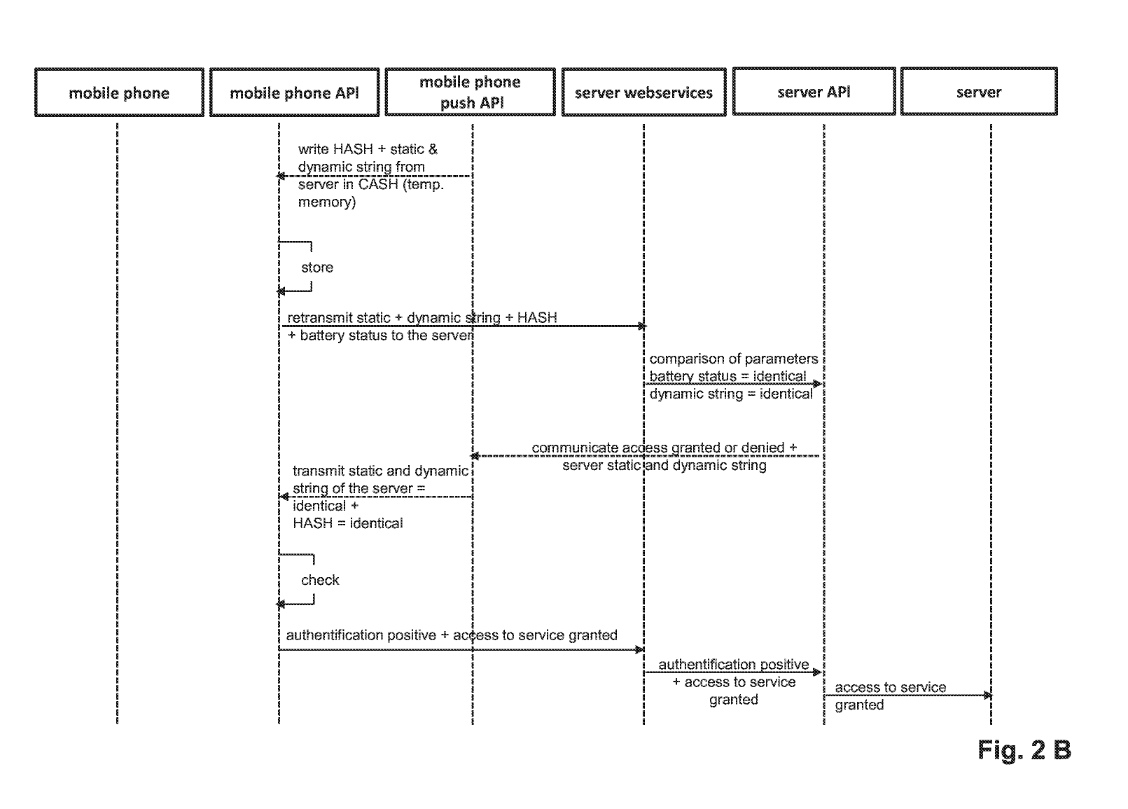

FIG. 10 shows another example. Here, the dynamic security information C is shifted to the right against the safety information A, B, i.e. the high point A and the low point C have shifted in the profile. If there is a new authentication, this profile is stored in the storage means of the central database server. Based on the known security information A, B, an assignment to a particular person or a particular object is possible. The change in the dynamic security information C allows a legitimate authentication or identification of the person or the object. Condition is that the dynamic security information C has dynamically changed over the last query time and that the change corresponds to the expected change. Should the security information C have changed, but not in the expected manner or to the expected extent, then an authentication or identification would fail.

### 4^{th} Example

In this example, the method additionally comprises a pre-authentication as per the Handshake-principle.

1. A method for identification or authentication of a person and/or an object via an authentication device, comprising one or more acoustic security information that consists of at least one security information known to the authentication device and at least one changing dynamic security information, comprising the steps:
a) providing a storage means for depositing the acoustic security information, wherein said storage means comprises a database, in which the acoustic security information or data derived therefrom are stored,
b) assigning the acoustic security information or parts thereof to a person or an object,
c) transmitting the known acoustic security information and the dynamic security information stored or generated for the identifying or authenticating person or object at the time of authentication via a communication device,
d) comparing the transmitted known acoustic security information and the dynamic security information with the static and dynamic security information stored in the storage means,
wherein the person and/or the object is/are then positively authenticated, if the transmitted known acoustic security information matches the acoustic security information stored in the storage means and the transmitted dynamic security information has partially changed against the security information stored in the storage means compared to last query time, wherein during updating of the storage means the stored security information is replaced with the transmitted security information.

2. The method as claimed in 1, characterized in that the dynamic security information has changed, based on a physical, mathematical or chemical parameter or factor, an algorithm, time- or location-dependant in accordance with a rule stored in the authentication device, or by the behaviour, the manner of speech of the person or a characteristic of the person or the object.

3. The method as claimed in 1, characterized in that the signal information known to the authentication device relates to an acoustic signal information, or a signal information derived from an acoustic signal or signal mix that consist of known security information and dynamic security information.

4. The method according to claim 1, characterized in that the known and/or dynamic security information is generated by a signal generator and is available as acoustic security information in a signal or sound mix.

5. The method according to claim 1, characterized in that the known and/or dynamic security information are audio-visually represented through curves, signal sequences, symbols, colours, pictures, letters, numbers, notation or other signs.

6. The method according to claim 1, characterized in that the known and/or dynamic security information is not audible to human ear.

7. The method according to claim 1, characterized in that the known and/or the dynamic security information is selected from the group consisting of acoustic signals, envelope curves, noises, melodies, tone sequences, tones, voices, languages and voice parts, and dictions and expressions while speaking, language profiles, random noise, which can be picked up by technical means and/or represented.

8. The method according to claim 1, characterized in that the dynamic security information is at least partially superimposed by at least one known security information.

9. The method according to claim 1, characterized in that before, after or during authentication the known security information is converted into a dynamic security information or the dynamic security information into a known security information.

10. The method according to claim 1, characterized in that the acoustic safety information is superimposed and individual security information is dynamically changed.

11. The method according to claim 1, characterized in that the dynamic change of the dynamic security information is performed via a shift, increase or decrease, amplification, attenuation, modification, truncation, extension, exchange of the security information.

12. The method according to claim 1, characterized in that before the current authentication of the person or the object, a pre-authentication is interposed, in which before the actual authentication, first a transmission of security information takes place from a terminal to the authentication device, and then a return request from the authentication response to the terminal for the person or the object stored in the storage means.

13. The method according to claim 1, characterized in that the acoustic security information is assigned to dynamic security information in the form of an individual code, a network address, an internet address or other individual feature, wherein the dynamic security information includes both changing dynamic elements and rigid elements.

14. An authentication device comprising
a) a reading unit for analogue and/or digital security information,
b) a communication device for exchanging security information,
c) a storage means for central deposit of security information, in that the security information relating to the authentication device consists of known security information and changeable dynamic security information, and that authentication takes place according to the method of claim 1.
